(19) United States
(12) Patent Application Publication
(10) Pub. No.: US 2013/0290212 A1
(43) Pub. Date: Oct. 31, 2013

(54) SYSTEM AND METHOD FOR MANAGING RETURN MAIL INFORMATION

(71) Applicant: Electronics and Telecommunications Research Institute, (US)

(72) Inventor: Moon Sung PARK, Daejeon (KR)

(73) Assignee: Electronics and Telecommunications Research Institute, Daejeon (KR)

(21) Appl. No.: 13/857,576

(22) Filed: Apr. 5, 2013

(30) Foreign Application Priority Data
Apr. 25, 2012 (KR) 10-2012-0043306

(51) Int. Cl. G06Q 10/08

(52) U.S. Cl. CPC G06Q 10/083
USPC 705/337

(57) ABSTRACT

The present invention relates to a system and method for managing return information. The system includes a postman terminal configured to receive return information from mail using return information providing service and a return information management server configured to store the return information received from the postman terminal in a return information DB, generate statistics information based on the return information, store the generated statistics information in a statistics information DB, and provide the return information and the statistics information to a forwarding customer terminal in response to a request of the forwarding customer terminal. In accordance with the present invention, return processing details information, change-of-address details information, and mail image information for each reason of return of return mail are provided to a customer. Accordingly, costs necessary to forward mail can be minimized, and costs necessary to deliver mail to a forwarding customer again can be reduced.

### CROSS-REFERENCES TO RELATED APPLICATIONS

The present application claims priority under 35 U.S.C 119(a) to Korean Application No. 10-2012-0043306, filed on Apr. 25, 2012, in the Korean Intellectual Property Office, which is incorporated herein by reference in its entirety set forth in full.

### BACKGROUND

Exemplary embodiments of the present invention relate to a system and method for managing return information, and more particularly, to a system and method for managing return information which obtain return processing details information, change-of-address details information, and mail image information on return mail and provide the pieces of information to a mail forwarding customer.

In general, a variety of service providers or public institutions, such as credit card companies, insurance companies, wired and wireless communication service providers, and Korea Electric Power Corporation, manage information on the addresses and telephone numbers of their customers and deliver bills for payment, bills for telephone rates, and electricity bills to the customers by mail.

Furthermore, the addresses of customers are frequently changed because 20% or more of a nation move annually. The customers have to give a notification of change of addresses to their service providers whenever they move, but a rate of the notification of change of addresses is very low due to daily inconvenience or troublesomeness.

Since bills are erroneously delivered and thus the number of return mails is increased, lots of costs are wasted socially and economically and customers have many disadvantages because of arrearage charges due to a lapse of the deadline for payment.

In order to solve the problems, there has recently been suggested a method of inviting a number of customers to a membership on the Internet, directly receiving changed addressed and target transaction service provider lists from the member customers, and automatically processing a notification of change for a number of service providers.

The change-of-address automatic processing method is problematic in that important personal information may leak out on the Internet. The method of inviting a membership through the Internet is limited in securing customers.

Furthermore, in a conventional automatic mail sorting system, only information on the recipient address of mail can be read and a mail return task is chiefly performed manually. Accordingly, there are problems in that manpower is wasted and the time taken to process return mail is long.

A related prior art includes Korean Patent Registration No. 10-0577031 (May 10, 2006), entitled ‘On-line Address Management System and Method Thereof’.

### SUMMARY

An embodiment of the present invention relates to a system and method for managing return information, which are capable of processing and managing return mail efficiently by obtaining return processing details information and change-of-address details information for each reason of return of return mail.

In one embodiment, a system for managing return information includes a postman terminal configured to receive return information from mail using return information providing service and a return information management server configured to store the return information received from the postman terminal in a return information database (DB), generate statistics information based on the return information, store the generated statistics information in a statistics information DB, and provide the return information and the statistics information to a forwarding customer terminal in response to a request of the forwarding customer terminal.

In the present invention, the postman terminal receives the return information included in a barcode on the mail by recognizing and reading the barcode.

In the present invention, the system further includes a delivery station terminal configured to receive the return information from the postman terminal, temporally store the received return information, and send the stored return information to the return information management server.

In the present invention, the system further includes a mail sorting machine configured to receive the return information from the mail in a process of sorting mails and send the received return information to the return information management server.

In the present invention, the return information includes one or more of return processing details information, change-of-address details information, and mail image information on the mail.

In the present invention, the mail image information is generated by overlaying the return processing details information and the change-of-address details information on an image of the mail.

In the present invention, change-of-address information retrieved from a change-of-address notification details DB based on a change-of-address details receipt number is incorporated into the change-of-address details information, and the resulting change-of-address details information is stored in the return information DB.

In the present invention, the return information is deleted from the return information DB when a preset expiration period of the return information elapses based on a point of time at which the return information is stored in the return information DB.

In the present invention, the statistics information includes daily statistics information generated based on the return information whenever a reference time is reached every day, monthly statistics information generated based on the daily statistics information whenever a first set time of a first set date is reached every month, and annual statistics information generated based on the monthly statistics information whenever a second set time of a second set date is reached every year.

In the present invention, the statistics information includes one or more of pieces of information on the number of tasks for each reason of return, the number of changes of addresses obtained, and the number of mail images obtained, and the statistics information is classified into statistics information for each customer and statistics information for each post office.

In another embodiment, a method of managing return information includes receiving, by a postman terminal, return information from mail using return information providing service and sending, by the postman terminal, the return information to a return information management server; registering, by the return information management server, the return information received from the postman terminal with a return information DB; generating, by the return information management server, statistics information based on the return information and registering, by the return information management server, with a statistics information DB; and providing, by the return information management server, the return information and the statistics information to a forwarding customer terminal in response to a request of the forwarding customer terminal which has joined the return information providing service.

In the present invention, the receiving, by the postman terminal, of return information from mail using return information providing service and the sending, by the postman terminal, of the return information to a return information management server includes obtaining, by the postman terminal, return processing details information included in a first barcode on the mail by reading the first barcode and obtaining, by the postman terminal, change-of-address details information included in a second barcode by recognizing and reading the second barcode if the second barcode is included in the mail.

In the present invention, the method further includes the receiving, by the postman terminal, of return information from mail using return information providing service and the sending, by the postman terminal, of the return information to a return information management server includes obtaining, by the postman terminal, an image of the mail by photographing the mail and obtaining, by the postman terminal, mail image information by processing the return processing details information and the change-of-address details information so that the return processing details information and the change-of-address details information are overlaid on the image.

In the present invention, in the receiving, by the postman terminal, of return information from mail using return information providing service and the sending, by the postman terminal, of the return information to a return information management server, the postman terminal sends the return information to the return information management server through a delivery station terminal.

In the present invention, in the registering, by the return information management server, of the return information received from the postman terminal with a return information DB, the return information management server deletes return information whose expiration period has elapsed based on a point of time at which the return information was registered with the return information DB from the return information DB.

In the present invention, in the providing, by the return information management server, of the return information and the statistics information to a forwarding customer terminal in response to a request of the forwarding customer terminal which has joined the return information providing service, the return information management server provides one or more of an Application Programming Interface (API) for downloading that allows the return information to be selectively downloaded and an API for address update that allows address information stored in the forwarding customer terminal to be updated.

In the present invention, in the providing, by the return information management server, of the return information and the statistics information to a forwarding customer terminal in response to a request of the forwarding customer terminal which has joined the return information providing service, the return information management server selectively provides change-of-address details information included in the return information depending on whether a recipient has consented to provide change-of-address information.

In the present invention, in the providing, by the return information management server, of the return information and the statistics information to a forwarding customer terminal in response to a request of the forwarding customer terminal which has joined the return information providing service, the return information management server provides service capable of outputting a label including the change-of-address information based on the change-of-address details information.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram of a system for managing return information in accordance with one embodiment of the present invention;

FIG. 2 is an exemplary diagram of the envelope of mail and a barcode including return information using return information providing service in the system for managing return information in accordance with one embodiment of the present invention;

FIG. 3 is an exemplary diagram of return processing details information in the system for managing return information in accordance with one embodiment of the present invention;

FIG. 4 is an exemplary diagram of change-of-address details information in the system for managing return information in accordance with one embodiment of the present invention;

FIG. 5 is an exemplary diagram of information in which return processing details information and change-of-address details information are combined in the system for managing return information in accordance with one embodiment of the present invention;

FIG. 6 is a flowchart illustrating a schematic operation of a method of managing return information in accordance with one embodiment of the present invention;

FIG. 7 is a detailed flowchart illustrating a process in which a postman terminal obtains return information in the method of managing return information in accordance with one embodiment of the present invention;

FIG. 8 is an exemplary diagram showing a process of obtaining return processing details information in the method of managing return information in accordance with one embodiment of the present invention;

FIG. 9 is an exemplary diagram showing a process of obtaining mail image information in the method of managing return information in accordance with one embodiment of the present invention;

FIG. 10 is a flowchart illustrating a process in which a mail sorting machine obtains return information in the method of managing return information in accordance with one embodiment of the present invention;

FIG. 11 is a detailed flowchart illustrating a process in which a postman terminal sends return information to a return information management server in the method of managing return information in accordance with one embodiment of the present invention;

FIG. 12 is a detailed flowchart illustrating a process in which a postman terminal sends return information to the return information management server through a delivery station terminal in the method of managing return information in accordance with one embodiment of the present invention;

FIG. 13 is a detailed flowchart illustrating a process in which the return information management server stores received return information in a return information DB in the method of managing return information in accordance with one embodiment of the present invention;

FIG. 14 is a detailed flowchart illustrating a process in which the return information management server generates statistics information based on return information and stores the generated statistics information in a statistics information DB in the method of managing return information in accordance with one embodiment of the present invention;

FIG. 15 is a detailed flowchart illustrating processes in which the return information management server provides return information at the request of a forwarding customer terminal in the method of managing return information in accordance with one embodiment of the present invention;

FIG. 16 is a first exemplary diagram showing a screen in which return information is provided in the method of managing return information in accordance with one embodiment of the present invention;

FIG. 17 is a second exemplary diagram showing a screen in which return information is provided in the method of managing return information in accordance with one embodiment of the present invention;

FIG. 18 is a third exemplary diagram showing a screen in which return information is provided in the method of managing return information in accordance with one embodiment of the present invention.

### DESCRIPTION OF SPECIFIC EMBODIMENTS

Hereinafter, a system and method for managing return information in accordance with some embodiments of the present invention will be described with reference to accompanying drawings. However, the embodiments are for illustrative purposes only and are not intended to limit the scope of the invention.

It is assumed that the system and method for managing return information in accordance with the present invention are applied to the return mail of a forwarding customer who has become a member of return information providing service.

The return information means overall information related to the return processing of return mail. The return information basically includes return processing details information and can further include change-of-address details information and mail image information depending on return information providing service.

That is, the return information providing service can be classified into basis service (service code: “00”) that provides return processing details information, first supplementary service (service code: “01”) that additionally provides change-of-address details information in the basis service, and second supplementary service (service code: “02”) that additionally provides mail image information on return mail in the first supplementary service.

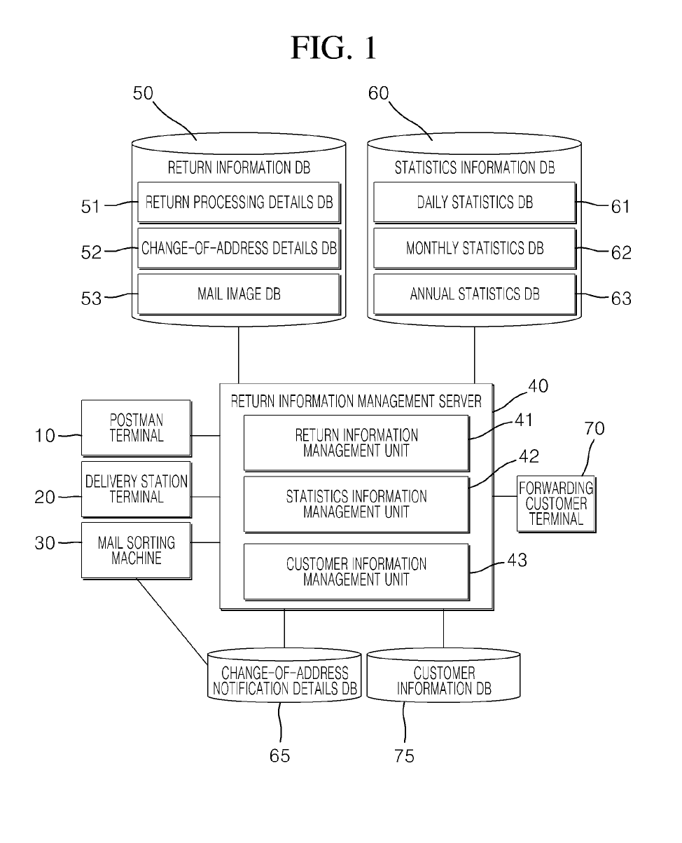

The system and method for managing return information in accordance with the present invention are described in detail below with reference to FIGS. 1 to 18.

FIG. 1 is a block diagram of the system for managing return information in accordance with one embodiment of the present invention.

As shown in FIG. 1, the system for managing return information in accordance with one embodiment of the present invention includes a postman terminal 10, a delivery station terminal 20, a mail sorting machine 30, a return information management server 40, a return information database (DB) 50, a statistics information DB 60, a change-of-address notification details DB 65, a forwarding customer terminal 70, and a customer information DB 75.

The postman terminal 10 receives return information from collected return mails and sends the return information to the return information management server 40.

The postman terminal 10 can be a variety of electronic devices, such as a Personal Digital Assistant (PDA), a smart phone, a mobile phone, a tablet PC, a notebook, and a net book, which can be connected to the Internet over a wireless communication network and carried by a postman.

The postman terminal 10 can include a barcode input module (not shown) capable of receiving barcodes and a barcode readout module (not shown) capable of reading out information stored in the barcode. The postman terminal 10 can obtain return information stored in a barcode by recognizing and reading the barcode on mail.

The postman terminal 10 can include an image acquisition module (not shown) capable of obtaining an image and an image processing module (not shown) capable of processing an obtained image. The postman terminal 10 can obtain mail image information.

Here, the image processing task of the image processing module can include a task of overlaying return processing details information and change-of-address details information, received through a barcode, on mail image information.

The delivery station terminal 20 receives return information from return mail and sends the return information to the return information management server 40, like the postman terminal 10. The delivery station terminal 20 can be a variety of electronic devices, such as a computer and a notebook installed in a delivery station, which can access the Internet over wired and wireless communication networks.

Furthermore, the delivery station terminal 20 may receive return information from the postman terminal 10, temporally store the received return information, and send the stored return information to the return information management server 40.

That is, if the postman terminal 10 cannot access the return information management server 40 over a wireless communication network, return information received from the postman terminal 10 may be temporally stored in the delivery station terminal 20 and then transmitted to the return information management server 40.

The mail sorting machine 30 is an apparatus for recognizing characters recorded on the mails and automatically sorting the mails in order of delivery. The mail sorting machine 30 receives return information from the mails while sorting the mails and sends the return information to the return information management server 40.

The mail sorting machine 30 includes a barcode input module (not shown), a barcode readout module (not shown), an image acquisition module (not shown), and an image processing module (not shown), like the postman terminal 10, and can further include a character recognition module (not shown) for recognizing characters recorded on mail.

Meanwhile, each of the postman terminal 10, the delivery station terminal 20, and the mail sorting machine 30 configured to obtain return information from mail as described above further includes memory (not shown) for temporally storing the obtained return information.

The return information management server 40 stores return information received from the postman terminal 10, the delivery station terminal 20, or the mail sorting machine 30 in the return information DB 50, generates statistics information based on the return information, stores the generated statistics information in the statistics information DB 60, and provides the return information stored in the return information DB 50 or the statistics information stored in the statistics information DB 60 at the request of the forwarding customer terminal 70.

The return information management server 40 includes a return information management unit 41 for managing return information, a statistics information management unit 42 for managing statistics information generated based on return information, and a customer information management unit 43 for managing information on a customer who has become a member of return information providing service.

The return information management unit 41 stores return information received from the postman terminal 10, the delivery station terminal 20, or the mail sorting machine 30 in the return information DB 50, provides the forwarding customer terminal 70 with return information, and deletes return information whose expiration period has been reached based on a point of time at which the return information was registered with the return information DB 50.

The statistics information management unit 42 generates daily, monthly, and annual statistics information based on return information, stores the generated daily, monthly, and annual statistics information in the statistics information DB 60, and provides the statistics information to the forwarding customer terminal 70.

The return information DB 50 stores return information, and it includes a return processing details DB 51 for storing return processing details information, a change-of-address details DB 52 for storing change-of-address details information, and a mail image DB 53 for storing information on an mage of return mail.

The statistics information DB 60 stores statistics information generated based on return information, and it includes a daily statistics DB 61 for storing daily statistics information, a monthly statistics DB 62 for storing monthly statistics information, and an annual statistics DB 63 for storing annual statistics information.

The forwarding customer terminal 70 is an apparatus for allowing a forwarding customer who has sent mail to access the return information management server 40 and receive return information and statistics information therefrom. The forwarding customer terminal 70 requests the return information management server 40 to provide return information and statistics information in response to the input of a forwarding customer and receives the return information and the statistics information from the return information management server 40.

The forwarding customer terminal 70 can be a variety of electronic devices, such as a computer, a notebook, a net book, a tablet PC, a smart phone, and a mobile phone, which can access the Internet over wired and wireless communication networks and display specific information.

The change-of-address notification details DB 65 stores a change-of-address details receipt number and change-of-address information depending on whether a recipient has consented to provide change-of-address information or not. The customer information DB 75 stores customer information, including the forwarding organization code and contract number of a forwarding customer who has become a member of return information providing service.

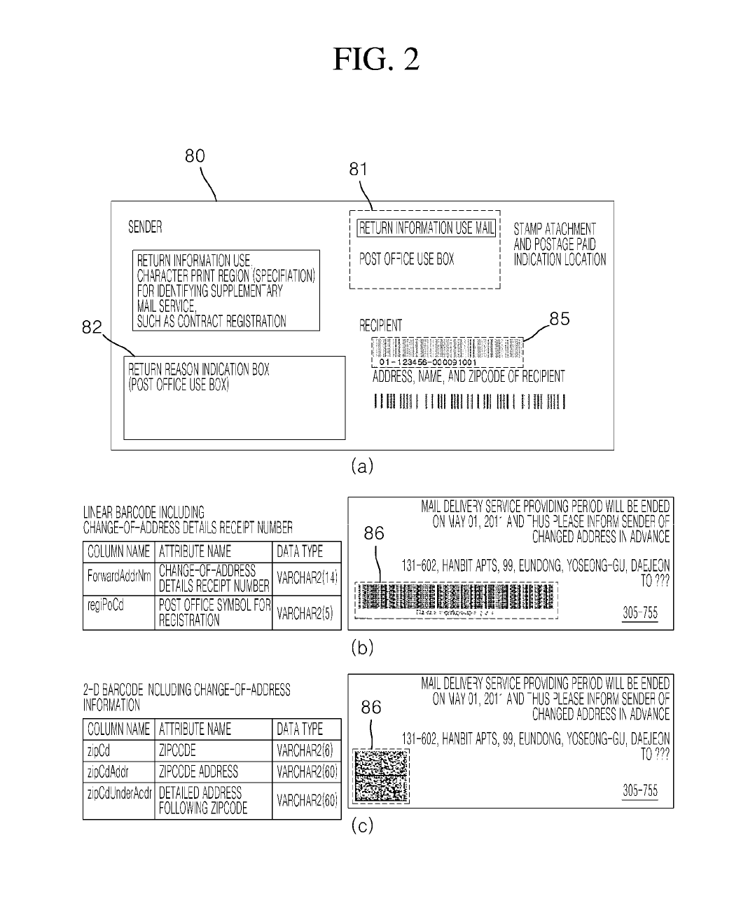

FIG. 2 is an exemplary diagram of the envelope of mail and a barcode including return information using return information providing service in the system for managing return information in accordance with one embodiment of the present invention.

As shown in FIG. 2(a), the envelope 80 of mail that has joined return information providing service includes a service check box 81 for indicating whether the return information providing service will be applied, a return reason box 82 for indicating a reason of return, and a first barcode 85 including return processing details information on the corresponding mail.

A passage “return information use mail” or a passage “return information use mail-image-” are written in the service check box 81. The latter case indicates that corresponding mail is mail which uses service for additionally providing mail image information on return mail. A reason of return is written in the return reason box 82.

As shown in FIG. 2(a), the first barcode 85 can include information “service code-forwarding organization code-personal mail ID” for corresponding mail. The first barcode 85 can be embodied using a linear barcode or a two-dimensional barcode including return processing details information.

Meanwhile, the envelope 80 of mail which uses service for receiving change-of-address details information can further include a second barcode 86 including change-of-address details information.

The second barcode 86 can be embodied using a linear barcode, including a change-of-address details receipt number and information regarding whether a recipient has consented to provide change-of-address information or not, or a two-dimensional barcode including change-of-address information as shown in FIGS. 2(b) and 2(c), respectively. The second barcode 86 can be printed in a label form and attached to the envelope 80.

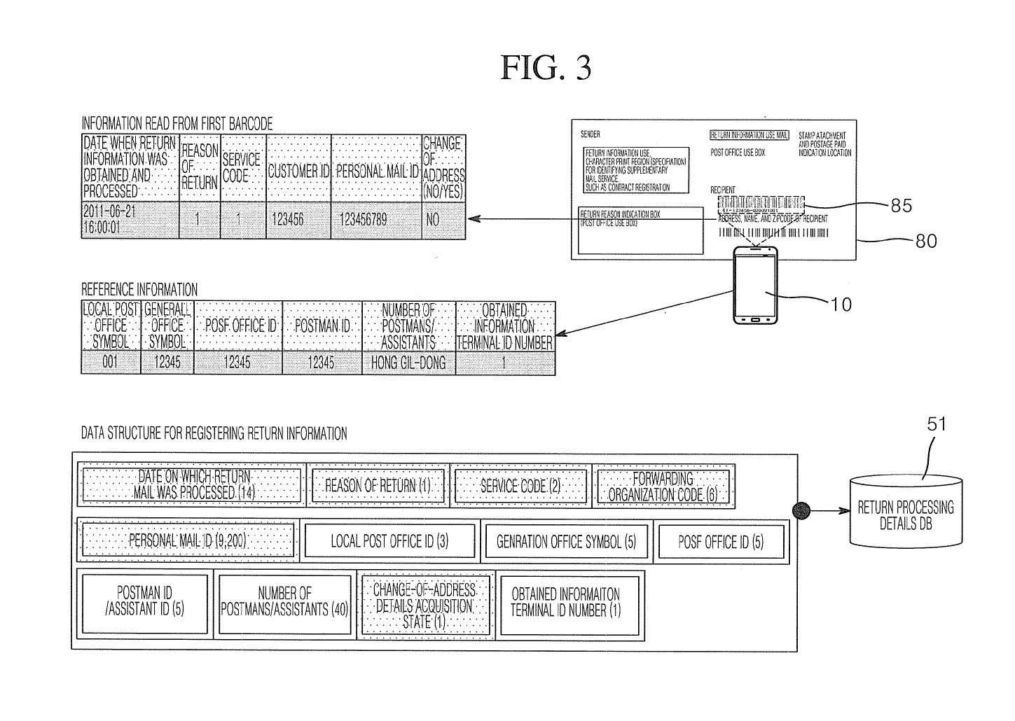

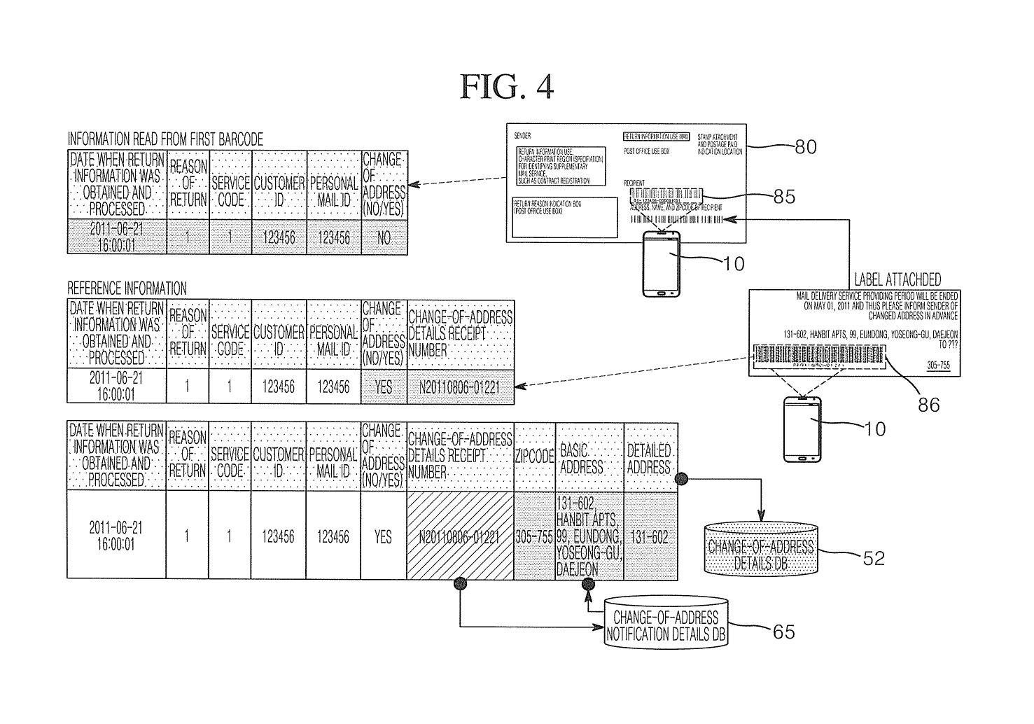

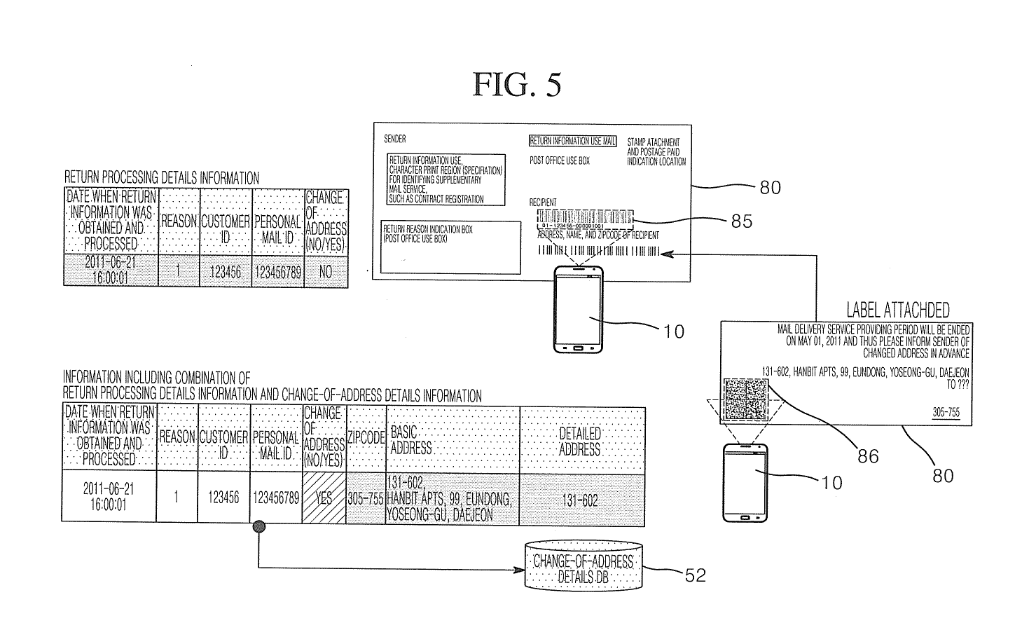

FIG. 3 is an exemplary diagram of return processing details information in the system for managing return information in accordance with one embodiment of the present invention, FIG. 4 is an exemplary diagram of change-of-address details information in the system for managing return information in accordance with one embodiment of the present invention, and FIG. 5 is an exemplary diagram of information in which return processing details information and change-of-address details information are combined in the system for managing return information in accordance with one embodiment of the present invention.

As shown in FIG. 3, the return processing details information can include a combination of information read out from the first barcode 85 by the postman terminal 10 and reference information stored in the postman terminal 10, and the return processing details information including the combined information can be stored in the return processing details DB 51.

As shown in FIG. 4, the change-of-address details information can include a combination of a change-of-address details receipt number read out from the second barcode 86 by the postman terminal 10 and change-of-address information retrieved from the change-of-address notification details DB 65 based on a change-of-address details receipt number, and the change-of-address details information including the combined information can be stored in the change-of-address details DB 52.

As shown in FIG. 5, a combination of the return processing details information read out from the first barcode 85 by the postman terminal 10 and the change-of-address details information read out from the second barcode 86 by the postman terminal 10 can be stored in the change-of-address details DB 52.

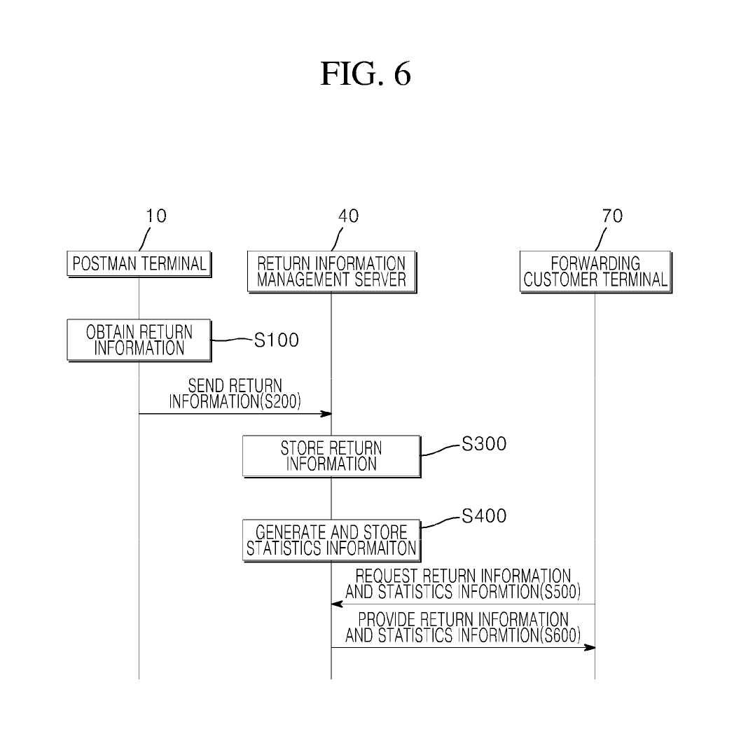

FIG. 6 is a flowchart illustrating a schematic operation of a method of managing return information in accordance with one embodiment of the present invention.

As shown in FIG. 6, the postman terminal 10 obtains return information, including return processing details information, change-of-address details information, and mail image information, from mail at step S100.

The postman terminal 10 sends the obtained return information to the return information management server 40 at step S200.

The return information management server 40 stores the received return information in the return information DB 50 at step S300. The return information management server 40 generates statistics information based on the received return information and stores the generated statistics information in the statistics information DB 60 at step S400.

Next, when a request for return information or statistics information is received from the forwarding customer terminal 70 at step S500, the return information management server 40 provides the forwarding customer terminal 70 with the return information stored in the return information DB 50 or the statistics information stored in the statistics information DB 60 at step S600.

Meanwhile, an example in which the postman terminal 10 is used in the process S100 of obtaining the return information from the mail has been described. The return information may be obtained from the delivery station terminal 20 or the mail sorting machine 30 as described above according to circumstances.

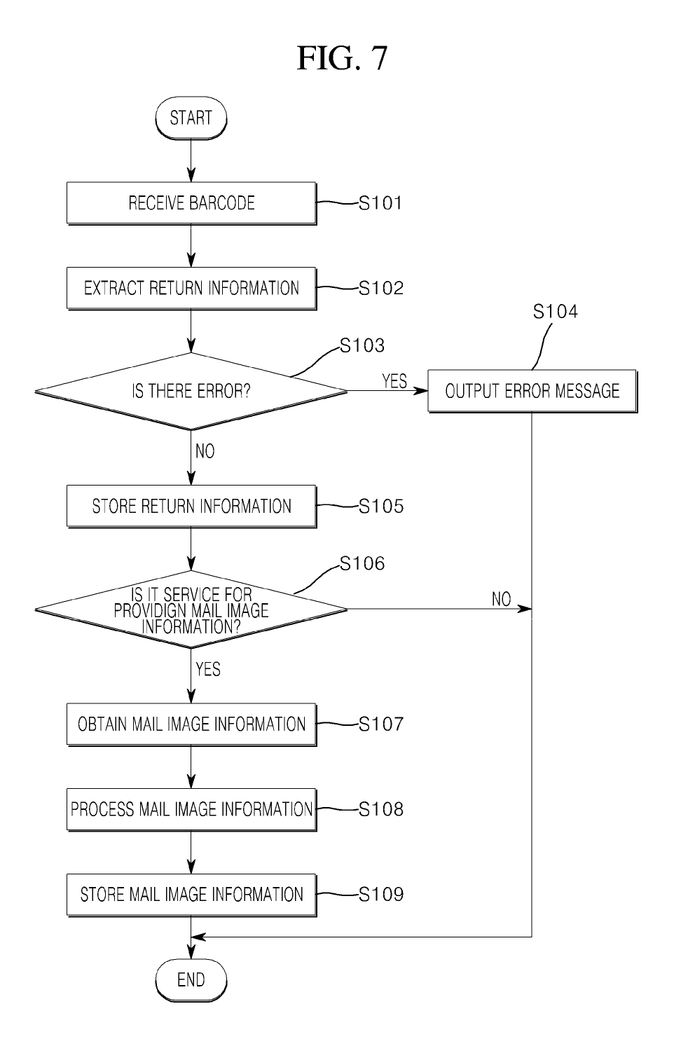

Operations of the method of managing return information in accordance with the present invention is described in detail below with reference to FIGS. 7 to 18.

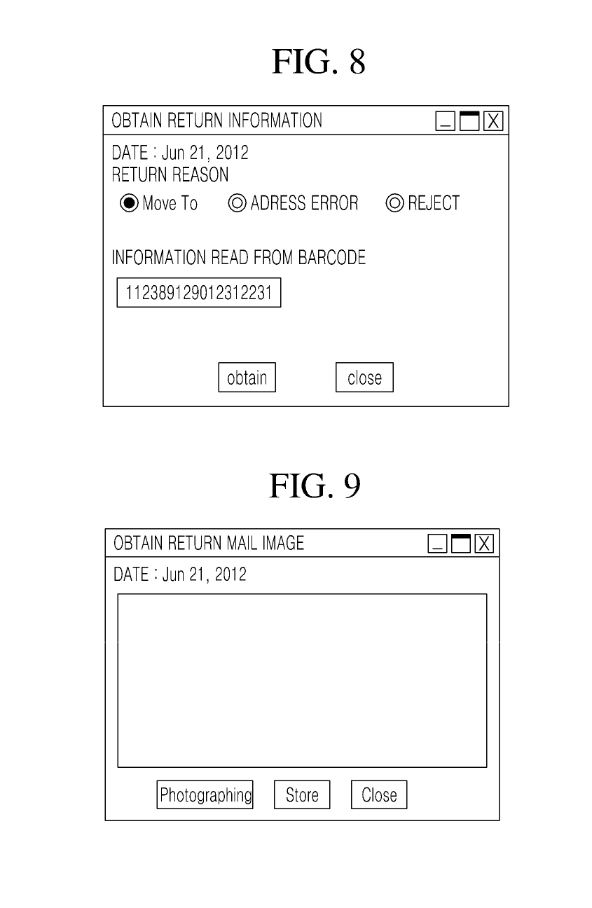

FIG. 7 is a detailed flowchart illustrating the process S100 in which the postman terminal 10 obtains return information in the method of managing return information in accordance with one embodiment of the present invention, FIG. 8 is an exemplary diagram showing a process of obtaining return processing details information in the method of managing return information in accordance with one embodiment of the present invention, and FIG. 9 is an exemplary diagram showing a process of obtaining mail image information in the method of managing return information in accordance with one embodiment of the present invention.

The postman terminal 10 receives a barcode on mail using the barcode input module at step S101 and extracts return information included in the barcode by reading the barcode using the barcode readout module at step S102. The extracted return information can be return processing details information or change-of-address details information, and an example of a screen that displays the return information obtained as described above is shown in FIG. 8.

The postman terminal 10 can also receive information on a reason of return from a postman. Here, the postman terminal 10 can receive the information on a reason of return from a barcode (not shown) for each reason of return that is owned by the postman.

The postman terminal 10 checks whether there is an error in the extracted return information or not at step S103. If, as a result of the check, it is checked that there is an error in the extracted return information, the postman terminal 10 outputs and displays an error message at step S104. If, as a result of the check, it is checked that there is no error in the extracted return information, the postman terminal 10 temporarily stores the extracted return information in the memory (not shown) at step S105.

Next, the postman terminal 10 determines whether the corresponding mail is mail using second supplementary service that provides mail image information based on the service code of the return information or not at step S106.

If, as a result of the determination, it is determined that the corresponding mail is mail using second supplementary service, that is, the service code is “02”, the postman terminal 10 obtains return mail image information using the image acquisition module at step S107.

Next, the postman terminal 10 performs processing using the image processing module so that the return information is overlaid on the mail image information at step S108 and temporarily stores the processed mail image information in the memory at step S109. An example of a screen that displays the mail image information obtained as described above is show in FIG. 9.

Here, the temporarily stored mail image information can have a file name: “unique post office number+operator ID+customer ID+personal mail ID+task date”.

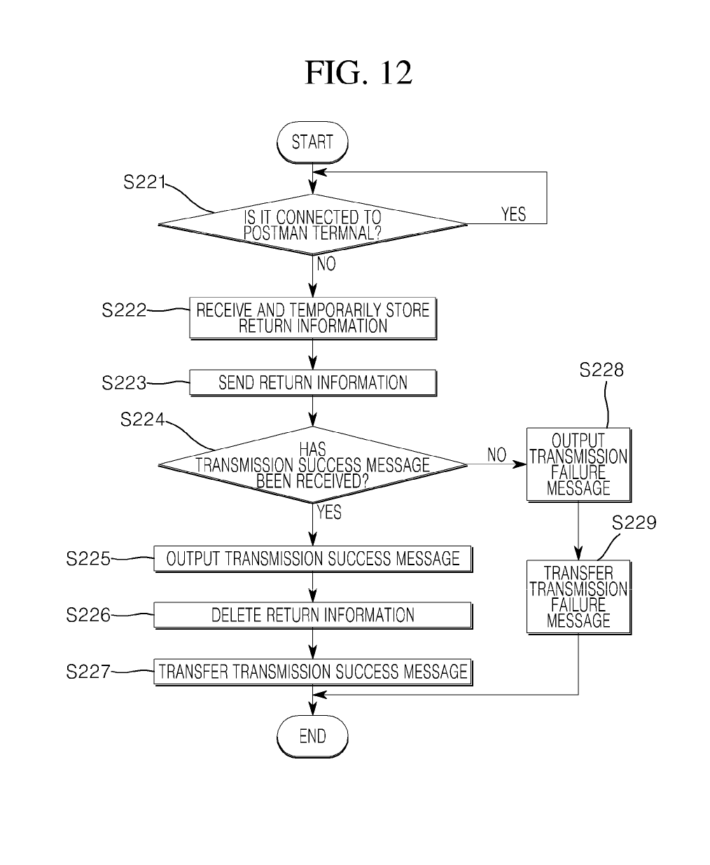

The return information stored in the memory of the postman terminal 10 as described above is transmitted to the return information management server 40 over a wireless communication network or through the delivery station terminal 20. This process is described later with reference to FIGS. 11 and 12.

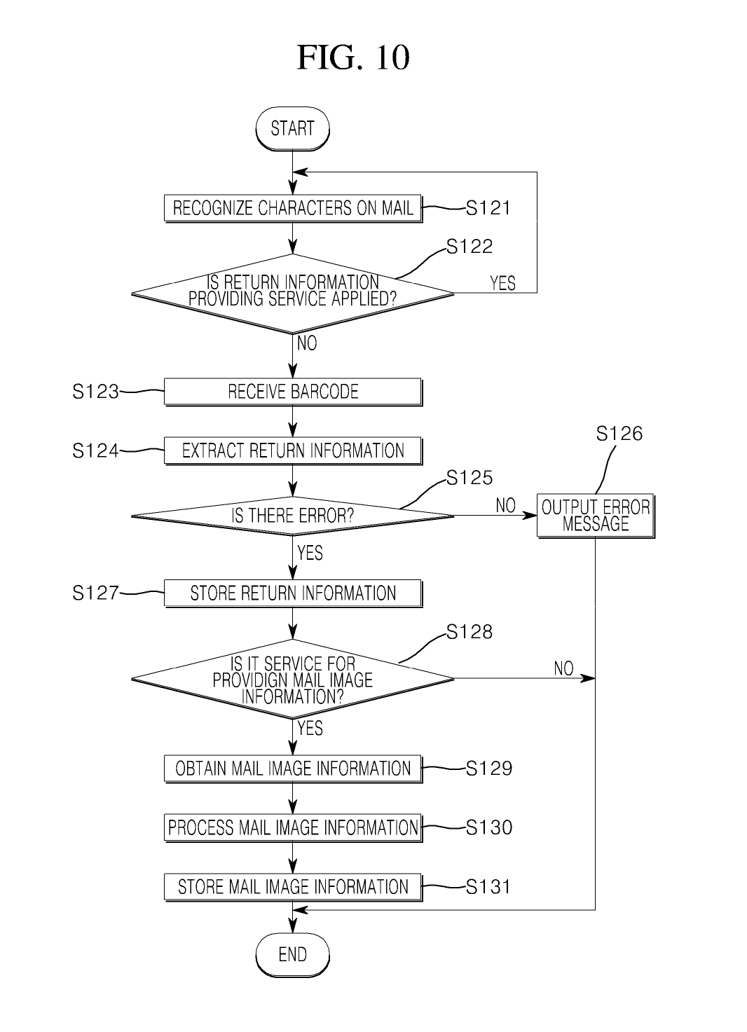

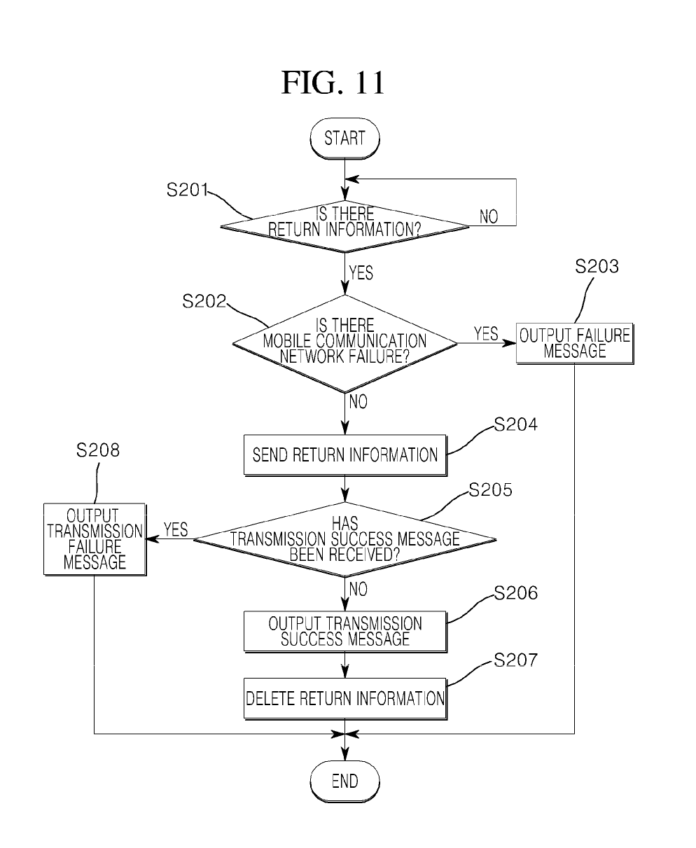

FIG. 10 is a flowchart illustrating a process S100 in which the mail sorting machine obtains return information in the method of managing return information in accordance with one embodiment of the present invention.

When mail is received, the mail sorting machine 30 recognizes characters recorded on the service check box 81 and the return reason box 82 using the character recognition module at step S121 and determines whether the mail is mail to which return information providing service is applied or not at step S122.

If, as a result of the determination, the mail is mail to which return information providing service is applied, the mail sorting machine 30 receives a barcode on the mail using the barcode input module at step S123 and extracts return information included in the barcode by reading the barcode using the barcode readout module at step S124.

Here, the mail sorting machine 30 can obtain information on a reason of return by recognizing characters or numbers recorded on the return reason box 82 or can obtain information on a reason of return by recognizing coordinates at a checked part of the check box for each reason of return that is included in the return reason box 82.

Furthermore, the mail sorting machine 30 can extract change-of-address information from the change-of-address notification details DB 35 based on a change-of-address receipt number included in the return information and generate change-of-address details information based on the extracted change-of-address information.

The mail sorting machine 30 checks whether there is an error in the extracted return information or not at step S125. If, as a result of the check, it is checked that there is an error in the extracted return information, the mail sorting machine 30 outputs and displays an error message at step S126. If, as a result of the check, it is checked that there is no error in the extracted return information, the mail sorting machine 30 temporarily stores the return information in its memory (not shown) at step S127.

Next, the mail sorting machine 30 determines whether the corresponding mail is mail using second supplementary service that provides mail image information based on the service code of the return information or not at step S128. If, as a result of the determination, it is determined that the corresponding mail is mail using second supplementary service, that is, the service code is “02”, the mail sorting machine 30 obtains return mail image information using the image acquisition module at step S129.

Next, the mail sorting machine 30 performs processing using the image processing module so that the return information is overlaid on the mail image information at step S130 and temporarily stores the processed mail image information in the memory at step S131.

Next, the mail sorting machine 30 transfers the corresponding mail to a return information use mail classification room (not shown). The return information stored in the memory of the mail sorting machine 30 is periodically transmitted to the return information management server 40 at a preset time interval (e.g., 15 minutes).

FIG. 11 is a detailed flowchart illustrating the process S200 in which the postman terminal 10 sends return information to the return information management server 40 in the method of managing return information in accordance with one embodiment of the present invention.

The postman terminal 10 checks whether there is return information in the memory or not at step S201. If, as a result of the check, it is checked that there is return information in the memory, the postman terminal 10 checks whether there is a failure in using a mobile communication network or not at step S202.

If, as a result of the check, it is checked that there is a failure in using the mobile communication network, it means that the transmission of the return information is impossible, and thus the postman terminal 10 outputs and displays a failure message at step S203.

If, as a result of the check, it is checked that there is no failure in using the mobile communication network, the postman terminal 10 sends the return information to the return information management server 40 at step S204 and checks whether a transmission success message has been received from the return information management server 40 through a mobile gateway or not at step S205.

If, as a result of the check at step S205, it is checked that the transmission success message has been received from the return information management server 40, the postman terminal 10 outputs and displays the transmission success message at step S206 and deletes the return information temporarily stored the memory at step S207.

If, as a result of the check at step S205, it is checked that the transmission success message has not been received from the return information management server 40, it means that the transmission of the return information failed, and thus the postman terminal 10 outputs and displays a transmission failure message at step S208.

FIG. 12 is a detailed flowchart illustrating the process S200 in which the postman terminal 10 sends return information to the return information management server 40 through the delivery station terminal 20 in the method of managing return information in accordance with one embodiment of the present invention.

An example in which the postman terminal 10 directly sends the return information to the return information management server 40 over a wireless communication network has been illustrated with reference to FIG. 11. If a wireless communication network is unavailable due to a failure in a mobile server, the return information obtained by the postman terminal 10 may be transmitted to the return information management server 40 via the delivery station terminal 20.

The delivery station terminal 20 checks whether the postman terminal 10 is connected thereto or not at step S221.

If, as a result of the check, it is checked that the postman terminal 10 is connected thereto, the delivery station terminal 20 receives return information from the postman terminal 10 and temporarily stores the received return information in the memory at step S222.

The delivery station terminal 20 sends the received return information to the return information management server 40 at step S223 and checks whether or not a transmission success message has been received from the return information management server 40 through a gateway at step S224.

If, as a result of the check at step S224, it is checked that the transmission success message has been received from the return information management server 40, the delivery station terminal 10 outputs and displays the transmission success message at step S225, deletes the return information temporarily stored in the memory at step S226, and then transfers the transmission success message to the postman terminal 10 at step S227.

If, as a result of the check at step S224, it is checked that the transmission success message has not been received from the return information management server 40, it means that the transmission of the return information has failed and thus the delivery station terminal 10 outputs and displays a transmission failure message at step S228 and transfers the transmission failure message to the postman terminal 10 at step S229.

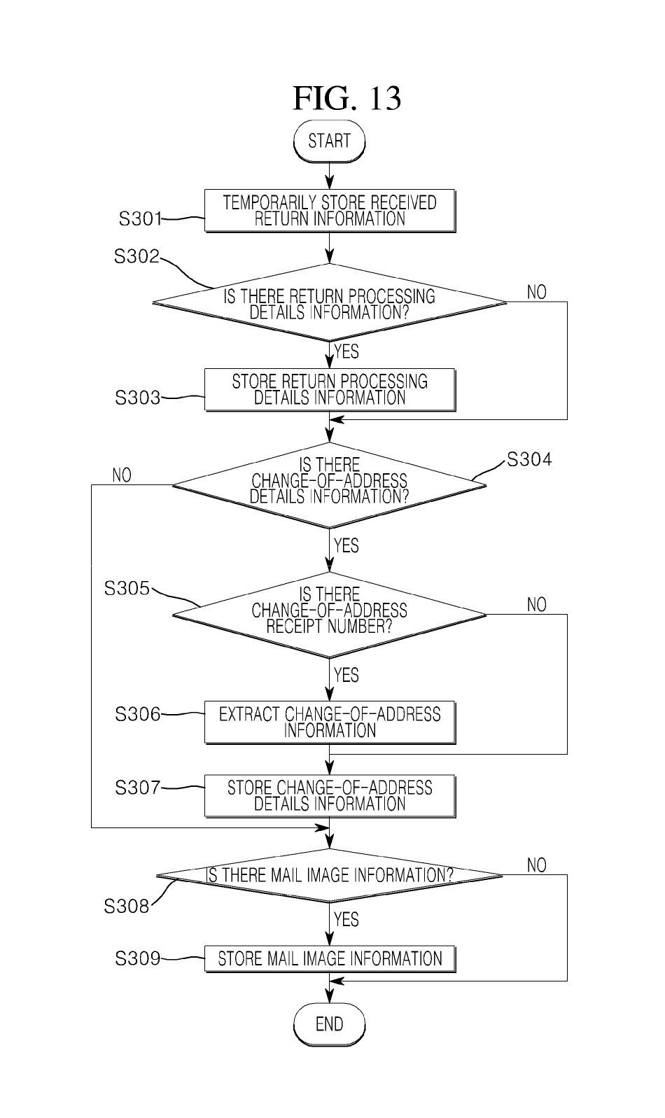

FIG. 13 is a detailed flowchart illustrating the process S300 in which the return information management server 40 stores received return information in the return information DB 50 in the method of managing return information in accordance with one embodiment of the present invention.

The return information management server 40 temporarily stores return information received from the postman terminal 10, the delivery station terminal 20, or the mail sorting machine 30 at step S301 and checks whether or not there is return processing details information to be registered with the return information DB 50 at step S302.

If, as a result of the check, it is checked that there is return processing details information to be registered with the return information DB 50, the return information management server 40 stores the return processing details information in the return processing details DB 51 of the return information DB 50 at step S303.

Next, the return information management server 40 checks whether there is change-of-address details information or not at step S304. If, as a result of the check at step S304, it is checked that there is change-of-address details information, the return information management server 40 checks whether there is a change-of-address details receipt number at step S305.

If, as a result of the check at step S305, it is checked that there is a change-of-address details receipt number, the return information management server 40 extracts change-of-address information, corresponding to the change-of-address details receipt number, from the change-of-address notification details DB 65 at step S306 and stores the change-of-address details information into which the extracted change-of-address information has been incorporated in the change-of-address details DB 52 of the return information DB 50 at step S307.

Meanwhile, if, as a result of the check at step S305, it is checked that there is no change-of-address details receipt number, the return information management server 40 stores the change-of-address details information in the change-of-address details DB 52 of the return information DB 50 at step S307.

Next, the return information management server 40 checks whether there is mail image information or not at step S308. If, as a result of the check at step S308, it is checked that there is mail image information, the return information management server 40 stores the mail image information in the mail image DB 53 of the return information DB 50 at step S309.

That is, the return information management server 40 stores the return processing details information in the return processing details DB 51, stores the change-of-address details information in the change-of-address details DB 52, and stores the mail image information in the mail image DB 53.

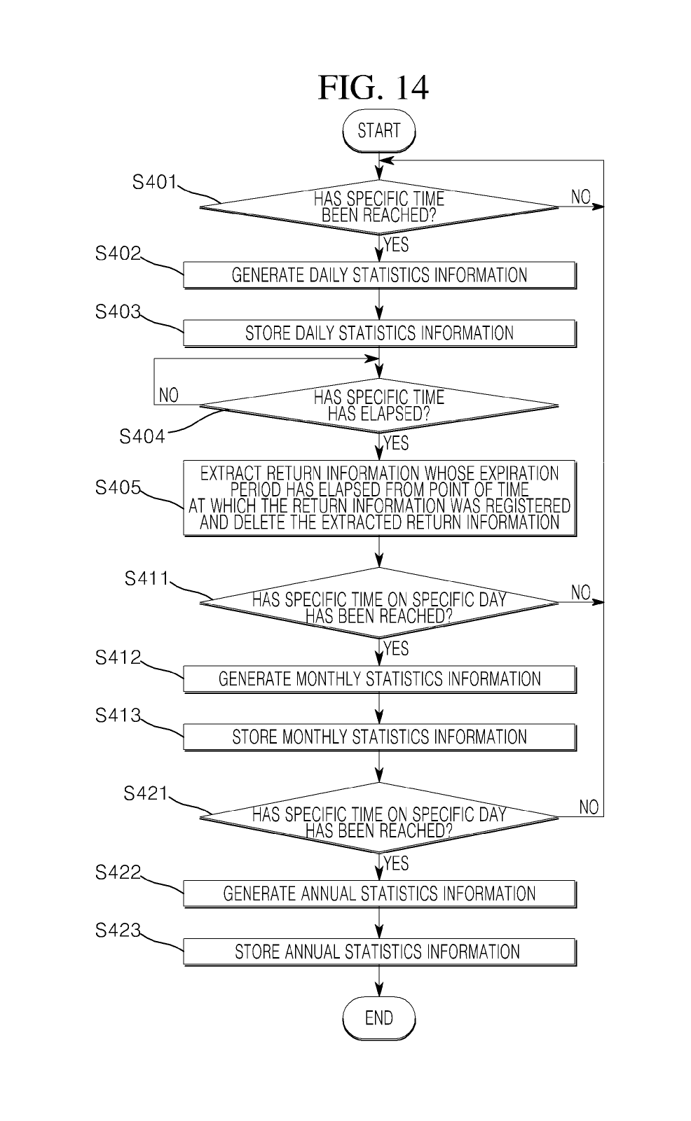

FIG. 14 a detailed flowchart illustrating the process S400 in which the return information management server 40 generates statistics information based on return information and stores the generated statistics information in the statistics information DB 60 in the method of managing return information in accordance with one embodiment of the present invention.

The return information management server 40 checks whether a specific time (e.g., 24:00 daily) daily set has been reached or not at step S401. If, as a result of the check, it is checked that a specific time has been reached, the return information management server 40 searches for return information on the corresponding day, generates daily statistics information based on a result of the search at step S402, and stores the generated daily statistics information in the daily statistics DB 61 of the statistics information DB 60 at step S403.

The return information management server 40 checks whether or not a specific time has elapsed from a point of time at which the daily statistics information was generated at step S404. If, as a result of the check at step S404, it is checked that the specific time has elapsed from the point of time, the return information management server 40 extracts return information whose expiration period (e.g., 3 months) has elapsed from a point of time at which the return information was registered and deletes the extracted return information from the return information DB 50 at step S405.

Next, the return information management server 40 checks whether or not a specific time on a specific day of each month (e.g., 01:00 on the 1^{st} day every month) has been reached at step S411. If, as a result of the check at step S411, it is checked that the specific time on the specific day of each month has been reached, the return information management server 40 generates monthly statistics information based on the daily statistics information stored in the daily statistics DB 61 at step S412 and stores the generated monthly statistics information in the monthly statistics DB 62 of the statistics information DB 60 at step S413.

Next, the return information management server 40 checks whether or not a specific time on a specific day of each year (e.g., 02:00 on the 1^{st} day of January every year) has been reached at step S421. If, as a result of the check at step S421, it is checked that the specific time on the specific day of each year has been reached, the return information management server 40 generates annual statistics information based on the monthly statistics information stored in the monthly statistics DB 62 at step S422 and stores the generated annual statistics information in the annual statistics DB 62 of the statistics information DB 60 at step S423.

Here, the statistics information can include the number of tasks for each reason of return, the number of changes of addresses obtained, and the number of mail images obtained.

Furthermore, each of the daily, monthly, and annual statistics information can be generated in the form of a mean value or a standard deviation value for each period and can be classified into statistics information for each customer and statistics information for each post office. The statistics information for each post office can be subdivided into statistics information for each postman.

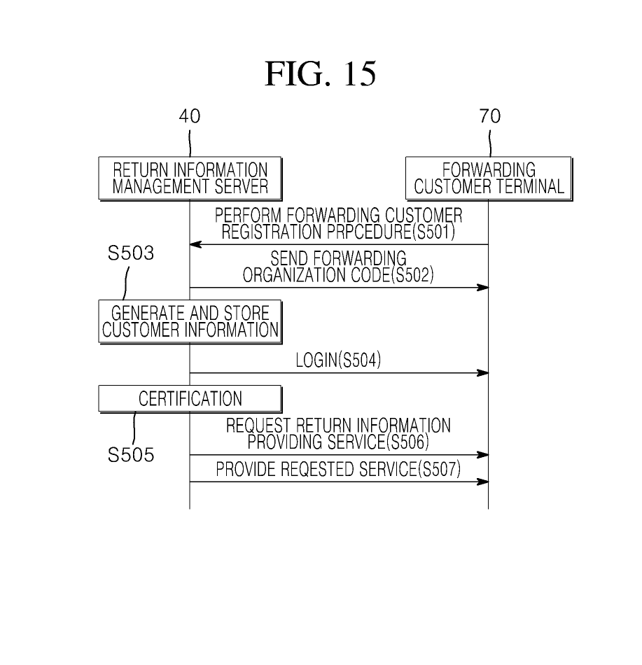

FIG. 15 is a detailed flowchart illustrating the processes S500 and S600 in which the return information management server 40 provides return information at the request of the forwarding customer terminal 70 in the method of managing return information in accordance with one embodiment of the present invention.

In order to use return information providing service, a forwarding customer has to submit an application paper in advance or has to access a web site, provided by the return information management server 40, through the forwarding customer terminal 70 and then perform a forwarding customer registration procedure at step S501.

In response thereto, the customer information management unit 43 of the return information management server 40 sends a forwarding organization code of 6 digits to the forwarding customer terminal 70 at step S502, generates customer information using a contract number and the forwarding organization code so that the forwarding customer can use the return information providing service and stores the generated customer information in the customer information DB 75 at step S503.

Next, the forwarding customer terminal 70 accesses the return information management server 40 in order to use the return information providing service and performs login at step S504.

The return information management server 40 certificates the login of the forwarding customer terminal 70 at step S505. When a request for return information or statistics information is received from the forwarding customer terminal 70 at step S506, the return information management server 40 extracts the requested return information or statistics information from the return information DB 50 or the statistics information DB 60 and provides the requested return information or statistics information to the forwarding customer terminal 70 at step S507.

Here, the forwarding customer terminal 70 can request services, such as “return information inquiry”, “download return information”, and “return information statistics inquiry” for each period or mail. In response to the request, the return information management server 40 can provide corresponding information to the forwarding customer terminal 70.

More particularly, when a request for return processing details information is received from the forwarding customer terminal 70, the return information management server 40 reads the return processing details information according to a forwarding organization code from the return processing details DB 51 and provides the read return processing details information to the forwarding customer terminal 70.

Furthermore, when a request for change-of-address details information is received from the forwarding customer terminal 70, the return information management server 40 reads the change-of-address details information according to a forwarding organization code from the change-of-address details DB 52 and provides the read change-of-address details information to the forwarding customer terminal 70.

Here, the return information management server 40 can selectively provide the change-of-address details information depending on whether a recipient has consented to provide change-of-address information. For example, if a recipient has consented to provide change-of-address information, the return information management server 40 provides change-of-address details information. If a recipient has not consented to provide change-of-address information, the return information management server 40 may not provide change-of-address details information or may provide only brief information on the recipient.

Meanwhile, the return information management server 40 can also provide an Application Programming Interface (API) for downloading that allows the forwarding customer terminal 70 to download return information or an API for address update that allows address information stored in the forwarding customer terminal 70 to be updated.

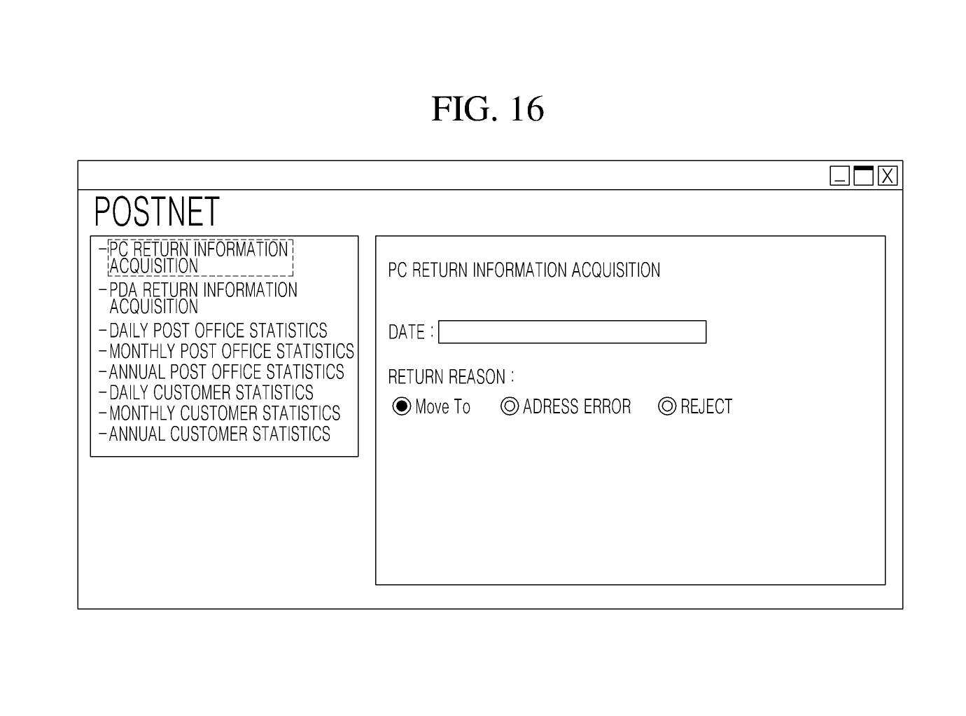

FIGS. 16 to 18 are first to sixth diagrams showing respective screens in which return information is provided in the method of managing return information in accordance with one embodiment of the present invention. FIGS. 16 to 18 show examples of screens in which the forwarding customer terminal 70 receives return information and statistics information from the return information management server 40.

Referring to FIG. 16, when the forwarding customer terminal 70 requests “PC return information acquisition”, the return information management server 40 provides inquiry service for return information that has been received from the delivery station terminal 20 and registered.

Likewise, when the forwarding customer terminal 70 requests “PDA return information acquisition”, the return information management server 40 inquiry service for return information that has been received from the postman terminal 10 and registered.

From FIG. 16, it can be seen that various pieces of statistics information, such as “daily, monthly, and annual post office statistics” and “daily, monthly, and annual customer statistics”, can be provided.

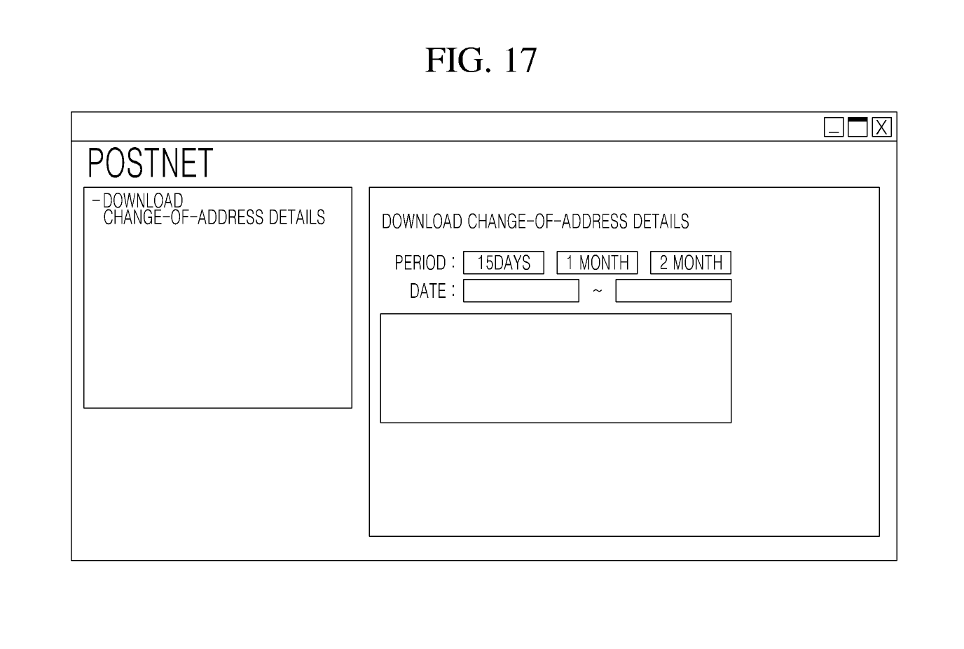

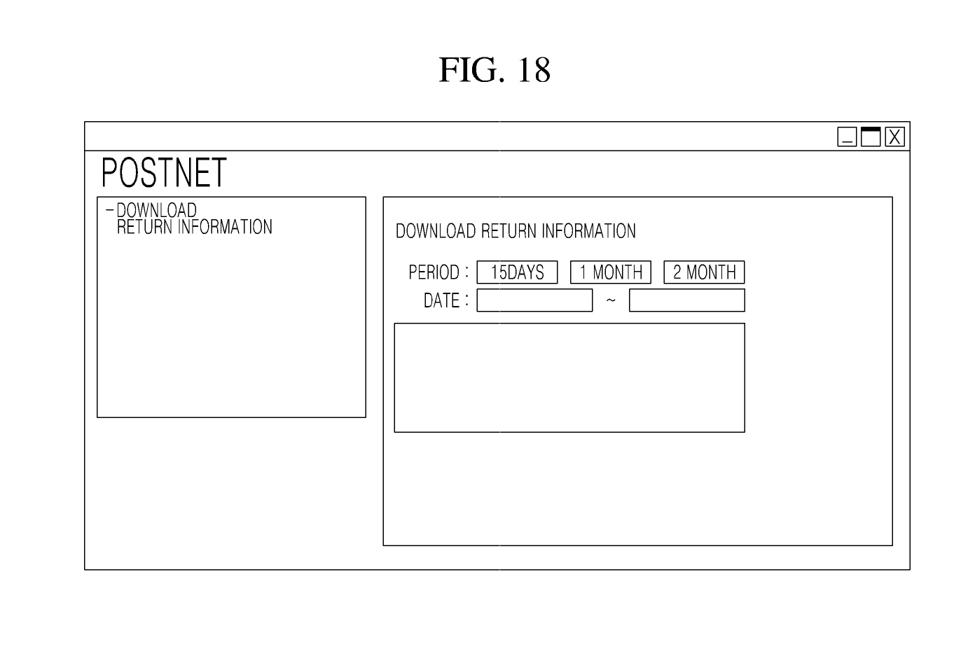

As shown in FIG. 17, the forwarding customer terminal 70 can receive change-of-address details information for each period from the return information management server 40 through “download change-of-address details”. As shown in FIG. 18, the forwarding customer terminal 70 can receive return processing details information for each period through “download return information”, and it can be provided with print service for the return processing details information.

The forwarding customer terminal 70 can selectively receive return processing details information or change-of-address details information for each item from the return information management server 40.

The forwarding customer terminal 70 can be provided with service for printing a label, including the change-of-address information, from the return information management server 40.

As described above, in accordance with the present invention, return processing details information, change-of-address details information, and mail image information for each reason of return of return mail are provided to a forwarding customer so that customer address information for forwarding is updated. Accordingly, from a viewpoint of a customer, costs necessary to forward mail can be minimized and mail service use convenience can be increased.

Furthermore, a delivery station can provide a forwarding customer with return information on return mail so that return mail is discarded. Accordingly, costs necessary to deliver the return mail to the forwarding customer again can be reduced, and thus the quality of mail delivery service can be improved.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A system for managing return information, comprising:
a postman terminal configured to receive return information from mail using return information providing service; and
a return information management server configured to store the return information received from the postman terminal in a return information database (DB), generate statistics information based on the return information, store the generated statistics information in a statistics information DB, and provide the return information and the statistics information to a forwarding customer terminal in response to a request of the forwarding customer terminal.

2. The system of claim 1, wherein the postman terminal receives the return information included in a barcode on the mail by recognizing and reading the barcode.

3. The system of claim 1, further comprising a delivery station terminal configured to receive the return information from the postman terminal, temporally store the received return information, and send the stored return information to the return information management server.

4. The system of claim 1, further comprising a mail sorting machine configured to receive the return information from the mail in a process of sorting mails and send the received return information to the return information management server.

5. The system of claim 1, wherein the return information comprises one or more of return processing details information, change-of-address details information, and mail image information on the mail.

6. The system of claim 5, wherein the mail image information is generated by overlaying the return processing details information and the change-of-address details information on an image of the mail.

7. The system of claim 5, wherein change-of-address information retrieved from a change-of-address notification details DB based on a change-of-address details receipt number is incorporated into the change-of-address details information, and the resulting change-of-address details information is stored in the return information DB.

8. The system of claim 5, wherein the return information is deleted from the return information DB when a preset expiration period of the return information elapses based on a point of time at which the return information is stored in the return information DB.

9. The system of claim 1, wherein the statistics information comprises:
daily statistics information generated based on the return information whenever a reference time is reached every day;
monthly statistics information generated based on the daily statistics information whenever a first set time of a first set date is reached every month; and
annual statistics information generated based on the monthly statistics information whenever a second set time of a second set date is reached every year.

10. The system of claim 1, wherein:
the statistics information comprises one or more of pieces of information on a number of tasks for each reason of return, a number of changes of addresses obtained, and a number of mail images obtained, and
the statistics information is classified into statistics information for each customer and statistics information for each post office.

11. A method of managing return information, comprising:
receiving, by a postman terminal, return information from mail using return information providing service and sending, by the postman terminal, the return information to a return information management server;
registering, by the return information management server, the return information received from the postman terminal with a return information database (DB);
generating, by the return information management server, statistics information based on the return information and registering, by the return information management server, with a statistics information DB; and
providing, by the return information management server, the return information and the statistics information to a forwarding customer terminal in response to a request of the forwarding customer terminal which has joined the return information providing service.

12. The method of claim 11, wherein the receiving, by a postman terminal, of return information from mail using return information providing service and the sending, by the postman terminal, of the return information to a return information management server comprises:
obtaining, by the postman terminal, return processing details information included in a first barcode on the mail by reading the first barcode; and
obtaining, by the postman terminal, change-of-address details information included in a second barcode by recognizing and reading the second barcode if the second barcode is included in the mail.

13. The method of claim 12, further comprising:
the receiving, by a postman terminal, of return information from mail using return information providing service and the sending, by the postman terminal, of the return information to a return information management server comprises:
obtaining, by the postman terminal, an image of the mail by photographing the mail; and
obtaining, by the postman terminal, mail image information by processing the return processing details information and the change-of-address details information so that the return processing details information and the change-of-address details information are overlaid on the image.

14. The method of claim 11, wherein in the receiving, by a postman terminal, of return information from mail using return information providing service and the sending, by the postman terminal, of the return information to a return information management server, the postman terminal sends the return information to the return information management server through a delivery station terminal.

15. The method of claim 11, wherein in the registering, by the return information management server, of the return information received from the postman terminal with a return information database (DB), the return information management server deletes return information whose expiration period has elapsed based on a point of time at which the return information was registered with the return information DB from the return information DB.

16. The method of claim 11, wherein in the providing, by the return information management server, of the return information and the statistics information to a forwarding customer terminal in response to a request of the forwarding customer terminal which has joined the return information providing service, the return information management server provides one or more of an Application Programming Interface (API) for downloading that allows the return information to be selectively downloaded and an API for address update that allows address information stored in the forwarding customer terminal to be updated.

17. The method of claim 11, wherein in the providing, by the return information management server, of the return information and the statistics information to a forwarding customer terminal in response to a request of the forwarding customer terminal which has joined the return information providing service, the return information management server selectively provides change-of-address details information included in the return information depending on whether a recipient has consented to provide change-of-address information.

18. The method of claim 17, wherein in the providing, by the return information management server, of the return information and the statistics information to a forwarding customer terminal in response to a request of the forwarding customer terminal which has joined the return information providing service, the return information management server provides service capable of outputting a label including the change-of-address information based on the change-of-address details information.
